(19) United States
(12) Patent Application Publication
(10) Pub. No.: US 2004/0060955 A1
(43) Pub. Date: Apr. 1, 2004

(54) Tape-cutting device

(76) Inventors: Fang-Kun Cheng, Yungkang City (TW); Chang-He Jou, Junghe City (TW); Chih-Hung Lo, Taichung (TW)

Correspondence Address: RABIN & BERDO, P.C., Suite 500, 1101 14th Street, N.W., Washington, DC, 20005, US

(21) Appl. No.: 10/254,880

(22) Filed: Sep. 26, 2002

(51) Int. Cl. B26F 3/02

(52) U.S. Cl. 225/6; 225/77

(57) ABSTRACT

A tape-cutting device includes a bladed main body and a holding member. The main body straddles an outer circumferential surface of a ring-shaped tape, and includes a top portion having a blade provided at a front edge thereof and two legs downward extended from two rear lateral sides of the top portion with a plurality of locating slots vertically spaced thereon. The holding member has two insertion slots formed near two lateral ends for engaging with the two legs of the main body so as to extend across an inner circumferential surface of the ring-shaped tape. Each insertion slot has a locating block provided at an outer side thereof for selectively engaging with one of the locating slots on the legs of the main body. The tape-cutting device has small volume for mounting on the ring-shaped tape to quickly find a tape beginning and cut the tape.

### BACKGROUND OF THE INVENTION

The present invention relates to a cutting device, and more particularly to a tape-cutting device for mounting on a ring-shaped tape to facilitate finding of a tape beginning and cutting of the tape.

With the highly developed technologies, high-molecular techniques have been widely applied to people's life to provide all kinds of conveniences. One product of the high-molecular techniques is the adhesive tape being used by people to pack or bond articles. The adhesive tape is structurally tough and therefore not subjected to breaking easily. Most of the currently commercially available adhesive tapes are continuously wound into a ring. That is, a long tape is continuously wound around, for example, an outer circumferential surface of a paper reel to provide a ring-shaped tape. To use the ring-shaped tape, a tape beginning is located and a desired length of tape is pulled and cut from the ring with a pair of scissors, a knife, a razorblade, or a sharp means.

There are various kinds of tapes available in the markets In addition to the above-mentioned structurally tough adhesive tape that must be cut with a cutting means, there are also other tapes that can be torn with hands instead of any cutting device. However, the hand-tear tapes are special tapes being more expensive than other ordinary tapes and therefore have only a very small share in the markets. There is still another type of tape, such as the electrical tape, that has increased thickness but decreased toughness and can be torn with hands, provided a good skill and a sufficient amount of force are employed. However, the torn ends of the tape are not visually pleasant and adversely affected in terms of their bonding ability.

Moreover, since the ring-shaped tape has a bonding agent applied over a backside thereof and usually has a uniform color, for example, a clear color, for a whole length of tape thereof, it would be very difficult to locate the tape beginning once it is released and automatically attached back to the ring of the tape again. A user would have to take a lot of time to find the tape beginning for the next use of the tape. One of the ways to find the tape beginning is to move a finger along the outer surface of the ring-shaped tape. Even it is found and pulled up, the tape beginning tends to split and become inconvenient for use.

A tape dispenser has been developed in an attempt to solve the above-mentioned problems. The tape dispenser usually includes a heavy base for a ring-shaped tape to rotatably mount thereon, and a blade for cutting the tape. An advantage of the above-described tape dispenser is the tape beginning is attached to the blade after the tape is cut, and the user needs not to locate the tape beginning when using the tape next time. However, the tape dispenser has a base that is much heavier than the tape and occupies a large space, making the tape dispenser expensive and inconvenient for handling with hands. The user could only cut a small length of tape from the tape dispenser each time for packing or bonding purpose. In the case of packing or bonding a big-volume article and a long piece of tape is required, the conventional tape dispenser is apparently not suitable for use.

Another disadvantage of the conventional tape dispenser is the blade thereof is always exposed to the open space and is potentially dangerous to people.

It is therefore tried by the inventor to develop a tape-cutting device that has simple structure to enable production of the device at low cost and small volume to enable easy handling thereof, and therefore eliminates the drawbacks existed in the conventional tape dispenser.

### SUMMARY OF THE INVENTION

A primary object of the present invention is to provide a tape-cutting device that has small volume and can be produced at low cost, and can be conveniently handled with hands to cut a tape.

To achieve the above and other objects, the tape-cutting device of the present invention mainly includes a bladed main body and a holding member. The main body straddles an outer circumferential surface of a ring-shaped tape, and includes a top portion having a blade provided at a front edge thereof and two legs downward extended from two rear lateral sides of the top portion with a plurality of locating slots vertically spaced thereon. The holding member has two insertion slots formed near two lateral ends for engaging with the two legs of the main body so as to extend across an inner circumferential surface of the ring-shaped tape. Each insertion slot has a locating block provided at an outer side thereof for selectively engaging with one of the locating slots on the legs of the main body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a tape-cutting device according to an embodiment of the present invention;

FIG. 2 is an assembled perspective view of FIG. 1;

FIG. 3 shows the tape-cutting device of the present invention is mounted on a ring-shaped tape for use;

FIG. 4 shows the manner of using the tape-cutting device of the present invention to find and lift a tape beginning; and

FIG. 5 shows the manner of using the tape-cutting device of the present invention to cut the tape.

### DETAILED DESCRIPTION OF THE PREFERRED EMBODIMENTS

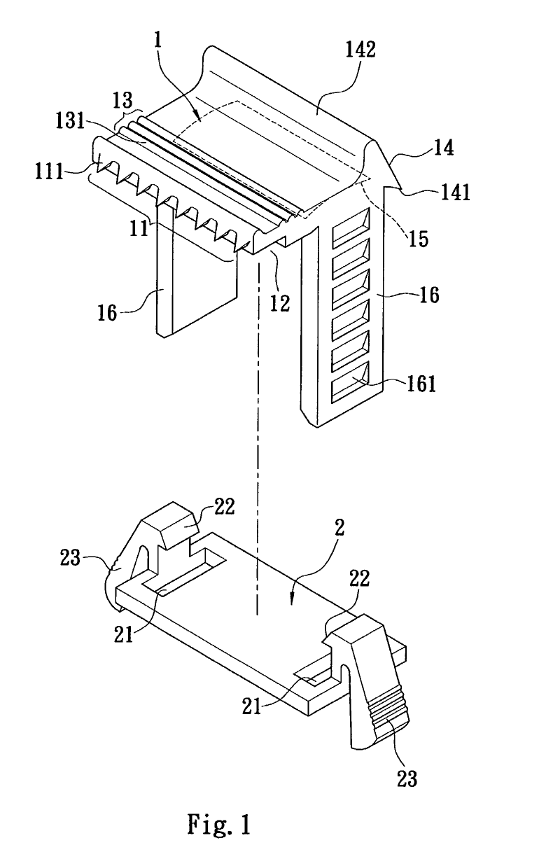

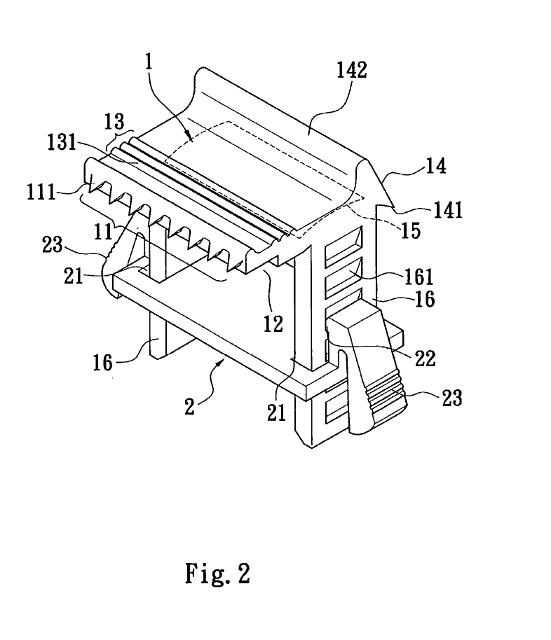

Please refer to FIGS. 1 and 2 that are exploded and assembled perspective views, respectively, of a tape-cutting device according to an embodiment of the present invention. As shown, the tape-cutting device includes a bladed main body 1 and a holding member 2.

The bladed main body 1 includes a substantially flat top portion and two symmetrical legs 16 downward extended from two rear lateral sides of the top portion. The top portion is transversely provided along a front edge with a downward and outward inclined blade 11 that includes a plurality of horizontally spaced pointed teeth 111. A lower front of the top portion has a reduced thickness to form a stepped area 12. That is, there is a height difference between an area immediately below and behind the blade 11 and the rest part of a lower surface of the top portion. An area of an upper surface of the top portion immediately behind the blade 11 is provided with a plurality of transversely extended ribs 131 to form an anti-slip part 13. A rear edge of the top portion is a beveled surface 14, a lower rear end of which forms a tape-beginning finder 141, and an upper front end of which rises by a small distance to form a push part 142. The two downward extended legs 16 are located between the anti-slip part 13 and the beveled surface 14, and each has a plurality of vertically spaced locating slots 161 provided thereon. An area of the lower surface of the top portion between the two legs 16 is formed into a concave surface 15.

The holding member 2 is a substantially flat plate having two insertion slots 21 provided near two lateral ends thereof for receiving the two legs 16 of the bladed main body 1 therein. A flexible locating block 22 upward extends from an outer side of each insertion slot 21 and has a configuration corresponding to the locating slots 161 on the leg 16. An outer side of each locating block 22 downward and outward extends to provide a push plate 23. By pressing the two push plates 23 at the same time, the two locating blocks 22 are caused to engage with or disengage from two corresponding locating slots 161 on the two legs 16.

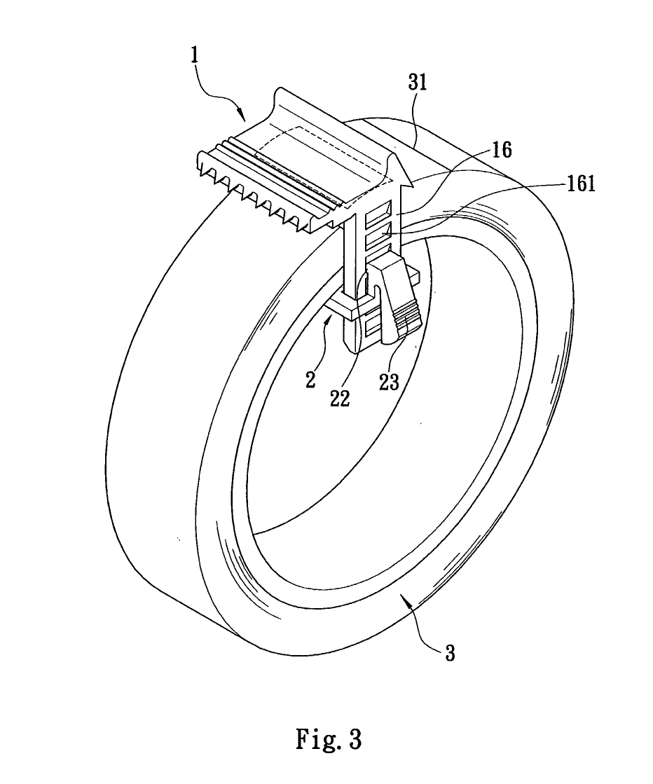

Please refer to FIG. 3 that shows a ring-shaped tape 3 having the tape-cutting device of the present invention mounted thereon. To mount the tape-cutting device on the tape, first allow the bladed main body 1 to straddle an outer circumferential surface of the ring-shaped tape 3 with the two legs 16 located at two lateral sides of the tape 3. The holding member 2 is then connected to the main body 1 to extend across an inner circumferential surface of the ring-shaped tape 3 by engaging the two insertion slots 21 with the two legs 16. By pressing the two push plates 23 at the same time, the locating blocks 22 are shifted outward to allow the holding member 2 to move along the legs 16 to a position very close to the tape 3. The push plates 23 are then released for the locating blocks 22 to engage with two corresponding locating slots 161 on the legs 16. Since there are more than one locating slot 161 on each leg 16 for engaging with the locating block 22, the holding member 2 may be freely adjusted to a desired position on the legs 16 relative to the top portion of the main body 1 according to an actual thickness of the ring-shaped tape 3 When the holding member 2 is located close to the inner circumferential surface of the tape 3, the lower concave surface 15 of the top portion of the bladed main body 1 is in contact with the outer circumferential surface of the tape 3, so that the tape 3 is stably but circumferentially movably held between the main body 1 and the holding member 2.

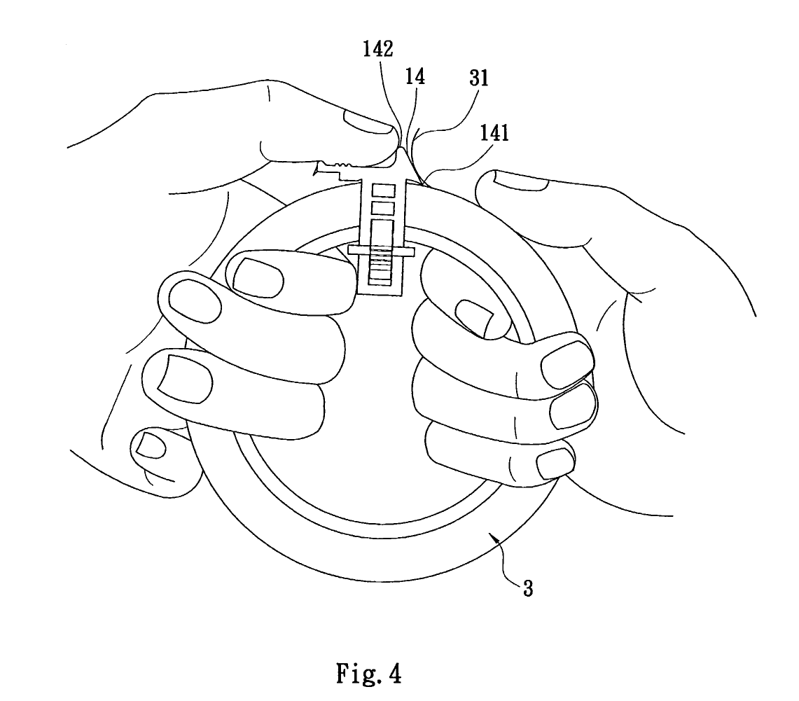

FIG. 4 shows the manner of using the tape-cutting device of the present invention to find and lift a tape beginning 31 of the tape 3 on which the cutting device is mounted. As shown in FIG. 4, the tape-cutting device is mounted on the ring-shaped tape 3 with the tape-beginning finder 141 at the lower rear end of the beveled surface 14 facing toward a direction opposite to a winding direction of the tape 3. By moving the tape-cutting device along the tape opposite to the tape winding direction and applying a minor force to the push part 142, the tape beginning 31 can be quickly found and lifted by the tape-beginning finder 141. The lifted tape beginning 31 rises along the beveled surface 14 and can be pulled from the tape 3 in any desired length for use. Since the tape 3 is circumferentially movably located between the main body 1 and the holding member 2 instead of being firmly clamped therebetween, a user may hold the tape-cutting device at outer sides of the two legs 16 to allow the tape 3 to rotate freely without hindering the user's movement of pulling the tape beginning 31.

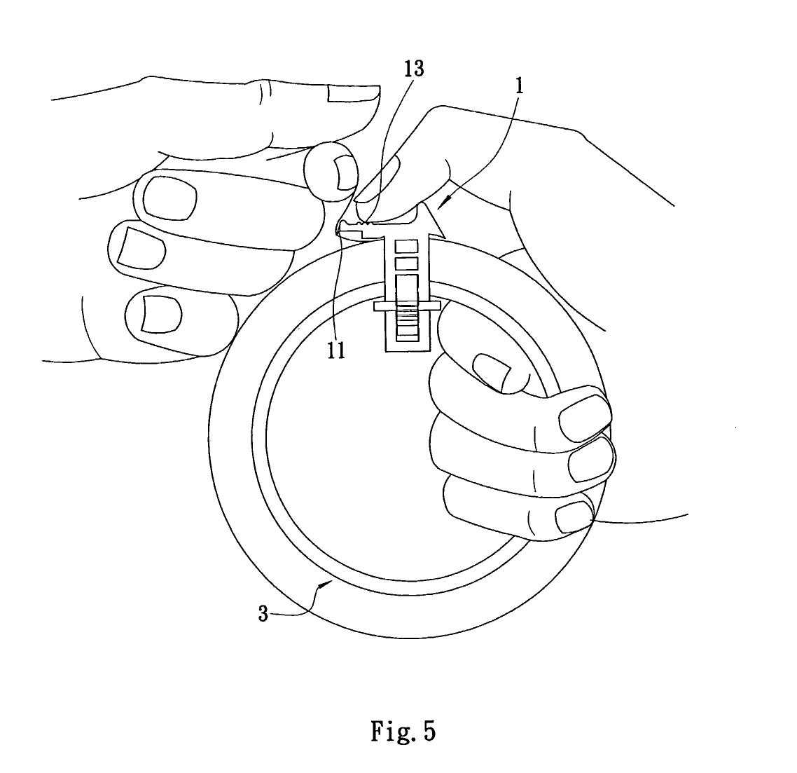

FIG. 5 shows the manner of cutting the tape 3 with the tape-cutting device of the present invention. When the tape beginning 31 has been pulled out with one hand to a desired length, the user may hold the tape 3 with the other hand and press the anti-slip part 13 to firmly contact the top portion of the main body 1 with the tape 3. The pulled length of the tape 3 may be then tightly pulled toward the blade 11 and cut thereat. Alternatively, the tape-cutting device may be pushed forward to cut the tightly pulled length of the tape 3 with the blade 11. Here, the anti-slip part 13 serves not only as an anti-slip surface but also a point of application to depress the top portion of the main body 1. The concave surface 15 below the top portion of the main body 1 allows the main body 1 to fitly contact with the outer circumferential surface of the ring-shaped tape 3, so that an increased surface friction between the main body 1 and the tape 3 can be obtained to stabilize the tape 3 when the anti-slip part 13 is depressed.

As mentioned above, the stepped area 12 formed below the blade 11 creates a height difference between the lower front and the rest areas of the lower surface of the top portion of the main body 1. With this height difference, a tape beginning 31 newly produced after the tape 3 is cut with the blade 11 is prevented from automatically sticking back to the outer circumferential surface of the tape 3 again. This is because the tape 3 is locally pierced and broken by the a plurality of pointed teeth 111 of the blade 11 when the original tape beginning 31 is tightly pulled toward the blade 11, and a toughness of the tape 3 is divided into two parts at the pierced areas of the tape 3, leaving the new tape beginning 31 on the tape 3 in a state without any remained tension. Therefore, the new tape beginning 31 remains attached to the pointed teeth 111 after the tape 3 has been cut and does not automatically stick back to the tape 3 again. When the main body 1 of the tape-cutting device is backward moved further, the new tape beginning 31 is raised and can be conveniently pulled up with one hand.

In conclusion, the tape-cutting device of the present invention has at least the following advantages:

1. It has simple structure and small volume to be produced at low cost, and can be mounted on a ring-shaped tape for convenient handling with hands.

2. The beveled surface 14 and the tape-beginning finder 141 enable quick and convenient finding and lifting of a tape beginning 31 stuck to the outer circumferential surface of the tape 3.

3. The stepped area 12 prevents the new tape beginning from automatically sticking back to the outer circumferential surface of the tape 3.

4. The blade 11 is downward and outward inclined from the front edge of the top portion of the main body 1 without directly exposing to an open space and is therefore safer for use.

The tape-cutting device of the present invention is therefore novel and more practical for use as compared with the conventional tape dispenser.

What is claimed is:

1. A tape-cutting device, comprising:
a bladed main body adapted to straddle an outer circumferential surface of a ring-shaped tape, said main body including a top portion, a front edge of which is transversely provided with a blade, and at least one leg downward extended from a rear lateral side of said top portion at a distance behind said blade to abut on one lateral side of said ring-shaped tape, and said at least one leg being provided with a plurality of locating slots; and
a holding member having at least one insertion slot formed near one lateral end for engaging with said at least one leg of said main body so as to extend across an inner circumferential surface of said ring-shaped tape, and said at least one insertion slot having a locating block provided at an outer side thereof for selectively engaging with one of said locating slots on said at least one leg of said main body.

2. The tape-cutting device as claimed in claim 1, wherein said locating slots on said at least one leg are vertically spaced from one another.

3. The tape-cutting device as claimed in claim 1, wherein said locating block has a downward and outward extended outer side to provide a push plate, and wherein said locating block can be shifted to engage with or disengage from said locating slots on said at least one leg of said main body by pressing said push plate against said holding member.

4. The tape-cutting device as claimed in claim 1, wherein said bladed main body is provided at two rear lateral sides with two said downward extended legs, and wherein said holding member is provided near two lateral ends with two said insertion slots corresponding to said two legs.

5. The tape-cutting device as claimed in claim 1, wherein said blade is downward and outward inclined from said front edge of said top portion of said main body.

6. The tape-cutting device as claimed in claim 1, wherein said blade includes a plurality of horizontally spaced pointed teeth.

7. The tape-cutting device as claimed in claim 5, wherein said blade includes a plurality of horizontally spaced pointed teeth.

8. The tape-cutting device as claimed in claim 1, wherein said top portion of said main body has a stepped area formed below and behind said blade, so that a height difference is created between a lower front area and other areas of a lower surface of said top portion.

9. The tape-cutting device as claimed in claim 1, wherein said top portion of said main body is provided at an upper surface behind said blade with an anti-slip part.

10. The tape-cutting device as claimed in claim 9, wherein said anti-slip part includes a plurality of transversely arranged ribs.

11. The tape-cutting device as claimed in claim 1, wherein said top portion of said main body is provided at a rear edge opposite to said blade with a beveled surface, and a lower rear end of said beveled surface is formed into a tape-beginning finder for finding and lifting a tape beginning.

12. The tape-cutting device as claimed in claim 11, wherein said beveled surface has a raised upper front end to provide a push part.

13. The tape-cutting device as claimed in claim 1, wherein an area of a lower surface of said top portion of said main body between said two legs is a concave surface adapted to contact with said outer circumferential surface of said ring-shaped tape.
